(19) United States
(12) Patent Application Publication
(10) Pub. No.: US 2023/0031953 A1
(43) Pub. Date: Feb. 2, 2023

(54) COATING AGENT FOR KITCHEN VENTILATION EQUIPMENT, COATING LIQUID FOR KITCHEN VENTILATION EQUIPMENT, METHOD FOR FACILITATING CLEANING OF KITCHEN VENTILATION EQUIPMENT MEMBER, AND METHOD FOR CLEANING KITCHEN VENTILATION EQUIPMENT MEMBER

(71) Applicant: 3M INNOVATIVE PROPERTIES COMPANY, St. Paul, MN (US)

(72) Inventor: Satoru Takinami, Kanagawa (JP)

(21) Appl. No.: 17/757,381

(22) PCT Filed: Dec. 10, 2020
(86) PCT No.: PCT/IB2020/061750

§ 371 Date: Jun. 15, 2022

(30) Foreign Application Priority Data
Dec. 16, 2019 (JP) 2019-226693

(51) Int. Cl. C11D 1/722; C11D 1/14; C11D 11/00

(52) U.S. Cl. CPC C11D 1/722; C11D 1/143; C11D 11/0058; C11D 11/0023

(57) ABSTRACT

To provide a coating agent for ventilation equipment, which can impart excellent easy cleaning property and can maintain easy cleaning property even in, for example, a high temperature and high humidity environment in kitchen ventilation equipment. A coating agent for kitchen ventilation equipment, which includes an anionic or nonionic surfactant having an alkyl chain, the alkyl chain having 16 or less carbon atoms, and the melting point of the surfactant being 50° C. or higher.

### TECHNICAL FIELD

The present invention relates to a coating agent for kitchen ventilation equipment, a coating liquid for kitchen ventilation equipment, a method for facilitating cleaning of a kitchen ventilation equipment member, and a method for cleaning a kitchen ventilation equipment member.

### BACKGROUND

In kitchen ventilation equipment that ventilates air containing oil particles, oil particles adhere to fans, range hoods, and others, and strains accumulate thereon. The adhered stains are very stubborn stains such as denatured oil and are often difficult to remove. Various proposals have been made as a method for removing stubborn stains; for example, Patent Document 1 proposes a method of removing stains by an alkaline cleaning composition including from 70 to 90% by weight of sodium percarbonate, 1 to 30% by weight of an alkaline granulated product, and from 1 to 25% by weight of a surfactant.

### CITATION LIST

### Patent Literature

[Patent Document 1] JP 61-44999 A

### SUMMARY

### Technical Problem

However, even when the above alkaline cleaning agent is used, it is not easy to remove the adhered stubborn stains, and it is necessary to soak the dirty member in boiling water containing a cleaning agent for a long time to float the stains, and then rub the dirty surface repeatedly and violently with a brush or the like. For more stubborn stains, the above operation needs to be repeated multiple times, and the cleaning operation requires a great deal of time and labor. Against this background, there is a demand for a method that can easily remove stains in a shorter time.

Therefore, an object of the present invention is to provide a coating agent for kitchen ventilation equipment, which can impart excellent easy cleaning property and can maintain easy cleaning property even in a high temperature and high humidity environment in the kitchen ventilation equipment. Another object of the present invention is to provide a coating liquid containing a coating agent, and a kitchen ventilation equipment member including a coating layer containing a coating agent. A further object of the present invention is to provide a method for facilitating cleaning of a kitchen ventilation equipment member, and a method for cleaning a kitchen ventilation equipment member.

### Solution to Problem

As a result of diligent studies to solve the above problems, the present inventors have found that cleaning can be performed more easily and in a short time by coating the surface to which stains adhere with a specific coating agent before the stains adhere, leading to the present invention.

One aspect of the present invention relates to a coating agent for kitchen ventilation equipment, which includes an anionic or nonionic surfactant having an alkyl chain, the alkyl chain having 16 or less carbon atoms, and the surfactant having a melting point of 50° C. or higher.

According to the above-mentioned coating agent for kitchen ventilation equipment (hereinafter may be referred to as “coating agent for ventilation equipment” or “coating agent”), it is possible to impart excellent easy cleaning property to a ventilation equipment member by forming a coating layer containing a coating agent on the kitchen ventilation equipment member (hereinafter may be referred to as “ventilation equipment member”). Further, in the coating agent, because the melting point of the surfactant is 50° C. or higher, dissolution of the coating layer in condensed water and fluidization of the coating layer at high temperatures (for example, 40° C.) are prevented, and the excellent easy cleaning property of the coating layer is maintained even in a high-temperature and high-humidity environment in kitchen ventilation equipment.

In one embodiment, the surfactant may be an anionic surfactant selected from the group consisting of sulphonate-based surfactants and sulphate-based surfactants.

In one aspect, the surfactant may be a nonionic surfactant having a polyoxyalkylene block.

Another aspect of the present invention relates to a coating liquid for kitchen ventilation equipment (hereinafter may be referred to as “coating liquid”) containing the coating agent for ventilation equipment and a solvent.

In one aspect, the content of the surfactant in the coating liquid may be from 3 to 50% by mass.

Yet another aspect of the present invention relates to a kitchen ventilation equipment member including a coating layer containing the coating agent.

Yet another aspect of the present invention relates to a method for facilitating cleaning of a kitchen ventilation equipment member, which includes a step of forming a coating layer containing the coating agent on the kitchen ventilation equipment member.

Yet another aspect of the present invention relates to a method for cleaning a kitchen ventilation equipment member including a coating layer containing the coating agent, in which the coating layer is dissolved in water to remove the coating layer and stains adhering to the coating layer.

### Advantageous Effects of Invention

The present invention provides a coating agent for kitchen ventilation equipment, which can impart excellent easy cleaning property and can maintain easy cleaning property even in a high temperature and high humidity environment in the kitchen ventilation equipment. The present invention also provides a coating liquid containing the coating agent, and a member for kitchen ventilation equipment including a coating layer containing the coating agent. The present invention also provides a method for facilitating cleaning of a kitchen ventilation equipment member and a method for cleaning a kitchen ventilation equipment member.

### DETAILED DESCRIPTION

Hereinafter, embodiments for carrying out the present invention will be described. The embodiments described below are examples of the embodiments of the present invention, and do not narrow the interpretation of the scope of the present invention. The upper and lower limit values of each numerical range may be optionally combined as desired.

### Coating Agent for Kitchen Ventilation Equipment

The coating agent for kitchen ventilation equipment (hereinafter may be referred to as “coating agent for ventilation equipment” or “coating agent”) according to the present embodiment contains an anionic or nonionic surfactant having an alkyl chain. The alkyl chain of the surfactant has 16 or less carbon atoms, and the melting point of the surfactant is 50° C. or higher.

The coating agent may have a plurality of alkyl chains, and at this time, each alkyl chain may be the same or different, and each alkyl chain may have 16 or less carbon atoms.

Since this coating agent contains a surfactant having an alkyl chain having 16 or less carbon atoms and a melting point of 50° C. or higher, it can impart excellent easy cleaning property to a kitchen ventilation equipment member (hereinafter, also simply referred to as “ventilation equipment member”). Further, this coating agent forms a coating layer in which dissolution in condensed water and fluidization at a high temperature (for example, 40° C.) are suppressed, so that the excellent easy cleaning property of the coating layer can be maintained even in a high-temperature and high-humidity environment in kitchen ventilation equipment (hereinafter, also simply referred to as “ventilation equipment”).

The reason why the above effect is achieved is not necessarily limited, but is considered as follows. First, by forming a coating layer with a coating agent in advance, stains adhere to the coating layer. After adhesion of the stains, removal of the coating layer from the venting equipment removes the stains together with the coating layer. At this time, since the stains and the ventilation equipment do not come into direct contact with each other, even stains (for example, oil stains) firmly adhering to the ventilation equipment can be easily removed.

Since the coating agent of the present embodiment contains a surfactant, it is considered that the surfactant takes in stains and forms micelles during cleaning. It is considered that this micelle formation suppresses the re-adhesion of stains to the surface from which the coating layer has been removed, and makes cleaning easier.

Since the coating agent of the present embodiment has 16 or less carbon atoms in the alkyl chain, it has a low affinity for oil stains, which are major stains. Therefore, it is considered that the oil stains accumulated on the coating layer are less likely to permeate into the coating layer, and more excellent easy cleaning property can be obtained.

Further, since the coating of the present embodiment has a melting point of 50° C. or higher, it does not easily flow in the typical temperature range in kitchen ventilation equipment, so that it is considered that the shape of the coating layer and excellent easy cleaning property can be maintained even at a place where centrifugal force is applied, such as the surface of a fan.

In this specification, the term “kitchen” indicates a place where food is cooked. Examples of the kitchen include kitchens in general houses; cooking facilities in business establishments such as restaurants, food retailers, hotels, hospitals, and factories; cooking rooms in schools, and public halls; galleys in passenger planes, trains, and ships.

The alkyl chain contained in the surfactant may be linear, branched or cyclic, and among these, linear or branched is preferable.

The alkyl chain contained in the surfactant may be an alkyl group at the end of the structure of the surfactant or an alkanediyl group in the structure of the surfactant. Further, these may be groups further substituted with a substituent (for example, a nitrogen-containing group).

Examples of the alkyl group include linear alkyl groups such as a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, and an n-hexadecyl group; and

branched alkyl groups such as an isopropyl group, an isobutyl group, a sec-butyl group, a tert-butyl group, an isopentyl group, a neopentyl group, an isohexyl group, an isoheptyl group, a 2-ethylhexyl group, an isooctyl group, an isononyl group, an isodecyl group, an isoundecyl group, an isododecyl group, an isotridecyl group, an isotetradecyl group, an isopentadecyl group, an isohexadecyl group, a neodecyl group, and a tert-dodecyl group.

Examples of the alkanediyl group include linear alkanediyl groups such as a methylene group, an ethylene group, a propane-1,3-diyl group, a butane-1,4-diyl group, a pentane-1,5-diyl group, a hexane-1,6-diyl group, a heptane-1,7-diyl group, an octane-1,8-diyl group, a nonan-1,9-diyl group, a decane-1,10-diyl group, an undecane-1,11-diyl group, and a dodecane-1,12-diyl group; and

branched alkanediyl groups such as an ethane-1,1-diyl group, a propane-1,1-diyl group, a propane-1,2-diyl group, a propane-2,2-diyl group, a pentane-2,4-diyl group, a 2-methylpropane-1,3-diyl group, a 2-methylpropane-1,2-diyl group, a pentane-1,4-diyl group, and a 2-methylbutane-1,4-diyl group.

The number of carbon atoms of the alkyl chain contained in the surfactant is preferably 14 or less, and more preferably 12 or less, from the viewpoint of more remarkably achieving the above-mentioned effects. The lower limit of the carbon number of the alkyl chain contained in the surfactant is not particularly limited, and may be, for example, 1 or more, or 2 or more.

The melting point of the surfactant is 50° C., preferably 60° C. or higher, and more preferably 80° C. or higher from the viewpoint of maintaining the easy cleaning property at a higher level even in commercial ventilation equipment where a higher temperature environment is expected compared to home ventilation equipment. The upper limit of the melting point of the surfactant is not particularly limited, and may be, for example, 400° C. or lower.

The surfactant may be an anionic surfactant or a nonionic surfactant, and may contain both an anionic surfactant and a nonionic surfactant.

Examples of the anionic surfactant include:

carboxylate-based surfactants such as alkylcarboxylate (carboxylate), polyalkoxycarboxylate, alcohol ethoxylate carboxylate, and alkylphenol ethoxylate carboxylate;

sulfonate-based surfactants such as alkyl sulfonates, alkyl aryl sulfonates, and sulfonated fatty acid esters;

sulfate-based surfactants such as sulfated alcohol, sulfated alcohol ethoxylate, sulfated alkylphenol, alkyl sulfate, sulfosuccinate, and alkyl ether sulfate; and

phosphoric acid ester-based surfactants such as phosphoric acid alkyl ester.

The anionic surfactant is preferably a surfactant selected from the group consisting of a sulfonate-based surfactant and a sulfate-based surfactant from the viewpoint that the above effects are more remarkably exhibited. The anionic surfactant is more preferably sodium alkylaryl sulfonate, alpha olefin sulfonate, aliphatic alcohol sulfate, or the like.

Examples of the nonionic surfactant include:

polyethylene glycol ether of an aliphatic alcohol;

polyethylene glycol ether of fatty alcohols endcapped by chlorination, benzylation, methylation, ethylation, propylation, butylation, or the like;

alkylpolyglycosides;

polyethylene glycol fatty acid esters;

polyhydric alcohol fatty acid esters such as glycerin fatty acid ester, pentaerythritol fatty acid ester, sorbitol fatty acid ester, sorbitan fatty acid ester, and sucrose fatty acid ester;

alkoxylated polyethyleneimine;

alcohol alkoxylates such as alcohol ethoxylate, alcohol ethoxylate propoxylate, alcohol propoxylate, alcohol propoxylate ethoxylate propoxylate, and alcohol ethoxylate butoxylate;

alkylphenol alkoxylates such as nonoxynols ethoxylates;

condensates of fatty acid and diethanolamine, condensates of fatty acid and monoalkanolamine, fatty acid amides such as polyoxyethylene fatty acid amide;

polyoxyalkylene block copolymers such as polyoxyethylene/polyoxypropylene block copolymers (for example, those available under the trade name of “PLURONIC”); and

silicone surfactants (for example, those available under the trade name “ABIL B8852”).

The nonionic surfactant is preferably a polyhydric alcohol fatty acid ester or a surfactant having a polyoxyalkylene block. The polyhydric alcohol fatty acid ester is more preferably polyoxyethylene sorbitan monolaurate. The surfactant having a polyoxyalkylene block is more preferably a surfactant having a polyoxyethylene block. In the polyoxyethylene block, —CH₂CH₂O— means a partial structure repeatedly connected.

Examples of the surfactant having a polyoxyethylene block include polyoxyethylene polyoxypropylene block copolymers (hereinafter also referred to as EO/PO block polymers). Examples of the EO/PO block copolymer include polymers represented by the following formulas:

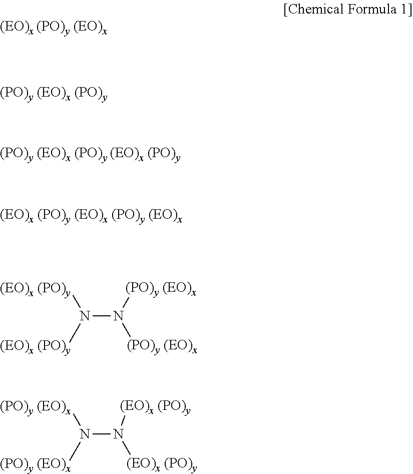

In the formulas, EO represents an ethylene oxide group, PO represents a propylene oxide group, and x and y represent integers of 2 or greater.

In a preferred embodiment, x may be from 10 to 130 and y may be from 15 to 70; x+y may be from 25 to 200; xs in one molecule may be different; and ys in one molecule may be different.

The molecular weight of the EO/PO block copolymer may be, for example, 400 or greater, 500 or greater, 950 or greater, or 1000 or greater. In addition, the molecular weight of the EO/PO block copolymer may be, for example, 7000 or less, 6700 or less, 4000 or less, or 3100 or less.

The above-mentioned EO/PO block copolymer has 3 to 8 blocks, but the number of blocks of the EO/PO block copolymer is not limited to this. The EO/PO block copolymer may be obtained as a commercial product, and can be obtained from, for example, BASF under the trade names of PLURONIC and TETRONIC.

The surfactant may be a commercially available product. Examples of the commercially available surfactant include “Emar 10PT” (sodium lauryl sulfate, manufactured by Kao Corporation), “Neoperex G-15” (sodium laurylbenzene sulfonate, manufactured by Kao Corporation,), and “Pluronic F68” (polyoxyethylene/polyoxypropylene vlock copolymer, manufactured by ADEKA Corporation), “Pluronic F88” (polyoxyethylene/polyoxypropylene block copolymer, manufactured by ADEKA Corporation), and “Pluronic F108” (polyoxyethylene/polyoxypropylene block copolymer, manufactured by ADEKA Corporation).

The ratio of the surfactant to the coating agent may be, for example, 50% by mass or greater, preferably 80% by mass or greater, more preferably 95% by mass or greater, and 100% by mass, based on the total amount of solid content.

The coating agent may be composed of only the surfactant (that is, the ratio of the surfactant to the coating agent may be 100% by mass), and may further contain other components other than the surfactant. Examples of the other components include an antifoaming agent, a pH adjuster, and a preservative.

When the coating liquid described later is applied by spraying, it is preferable that an antifoaming agent is added to the coating agent. Examples of the antifoaming agent include higher alcohol-based antifoaming agents, mineral oil-based antifoaming agents, and silicone-based antifoaming agents. Examples of the higher alcohol-based antifoaming agents include “Pronal C-78N” available from Toho Chemical Industry Co., Ltd. and “Bismer FS” available from Nisshin Kagaku Kenkyusho Co., Ltd. Examples of the mineral oil-based antifoaming agent include “Pronal C-448” available from Toho Chemical Industry Co., Ltd. and “SN Deformer 777” available from San Nopco Limited. Examples of the silicone-based antifoaming agent include “SN Deformer 399” available from San Nopco Limited and “BYK-025” available from BYK-Chemie GmbH. Of these, a silicone-based defoaming agent is preferable from the viewpoint that high antifoaming property can be easily obtained without impairing the above effects.

The amount of the antifoaming agent may be, for example, 0.01 part by mass or more with respect to 100 parts by mass of the surfactant. The amount of the antifoaming agent may be, for example, 5 parts by mass or less, preferably 1 part by mass or less, and more preferably 0.5 parts by mass or less with respect to 100 parts by mass of the surfactant.

The coating agent of the present embodiment can also be said to be an agent for facilitating cleaning of a kitchen ventilation equipment. Further, the coating agent of the present embodiment can also be said to be an anti-staining agent for stains (particularly modified oil stains) for kitchen ventilation equipment.

### (Coating Liquid for Kitchen Ventilation Equipment)

The coating liquid for kitchen ventilation equipment (hereinafter, may be simply referred to as “coating liquid”) of the present embodiment contains the above-mentioned coating agent and a solvent.

The solvent may be, for example, water or a mixed solution of water and alcohol. Examples of the alcohol include methanol, ethanol, n-propanol, 2-propanol, n-butanol, 2-butanol, and t-butanol. These may be used alone or in combination of two or more.

The content (concentration) of the surfactant in the coating liquid is preferably 3% by mass or greater, more preferably 5% by mass or greater, and even more preferably 10% by mass or greater, from the viewpoint that more excellent easy cleaning property can be easily obtained. The content (concentration) of the surfactant in the coating liquid is preferably 50% by mass or less, more preferably 30% by mass or less, and even more preferably 25% by mass or less, from the viewpoint that a low viscosity suitable for spray application can be easily obtained.

The coating liquid may further contain other components such as a pH adjuster, a film-forming aid, a curing agent, a curing accelerator, a curing retarder, a pigment, an antifreeze agent, a filler, an antifoaming agent, a preservative, an ultraviolet absorber, an antioxidant, a lubricant, and an algae repellent as necessary.

### Coating Member

By forming a coating layer containing the coating agent on a ventilation equipment member, a ventilation equipment member having an easy cleaning property (hereinafter, also referred to as a coating member) is obtained.

By having the coating layer containing the coating agent, the stains that are originally supposed to adhere to the ventilation equipment member can be adhered to the coating layer. By removing the stains on the coating layer together with the coating layer, the stains can be easily removed.

The coating member may be one in which at least a part of the ventilation equipment member is coated with the coating layer, and may be, for example, one in which a part of the ventilation equipment member to which stains easily adhere is selectively coated with the coating layer.

The ventilation equipment member is not particularly limited as long as it is a member used for the kitchen ventilation equipment, and may be a member that can be easily removed such as a ventilation fan, a filter, or a rectifying plate, or a member that is difficult to remove such as a wall surface of the main body of ventilation equipment.

Examples of the kitchen ventilation equipment include ventilation equipment installed in kitchens in general houses; cooking facilities in business establishments such as restaurants, food retailers, hotels, hospitals, and factories; kitchens in schools and public halls; and galleys in passenger planes, trains, and ships. Specific examples of these ventilation facilities include a range hood including a sirocco fan, a ventilation fan equipped with a propeller fan, and the like. In the present embodiment, a particularly remarkable effect is given to ventilation equipment having a complicated structure because a coating layer can be easily formed by applying a coating liquid, and it is difficult to remove stains from such equipment by an ordinary cleaning method. From this point of view, a range hood including a sirocco fan is suitable as the ventilation equipment of the present embodiment.

### Method for Facilitating Cleaning of Ventilation Equipment Member

The method for facilitating cleaning of a ventilation equipment member of the present embodiment includes a step of forming a coating layer containing the coating agent on a member for ventilation equipment.

The method of forming the coating layer on the ventilation equipment member is not particularly limited, and examples thereof include a method of applying a coating liquid to the ventilation equipment member and drying it. The coating method is not particularly limited, and may be, for example, spraying with a spray or the like, coating with a brush or the like, immersion in a coating liquid, or the like.

The coating liquid may be dried, for example, at room temperature or at a temperature at which the formed coating layer does not fluidize (for example, 40° C. or lower). The drying time may be adjusted by adjusting the concentration of the coating agent in the coating liquid, the drying temperature, etc., and may be, for example, 30 minutes or more, or 1 hour or more.

The ventilation equipment member on which the coating layer is formed can be used as the original ventilation equipment member even when the coating layer is formed. Therefore, after the coating layer is formed on the ventilation equipment member, the ventilation equipment member can be attached to the main body of the range hood device. The coating layer can also be formed directly on a ventilation equipment member attached to the main body of the ventilation equipment.

### Method of Cleaning Ventilation Equipment Member

The method for producing a ventilation equipment member of the present embodiment is a method for cleaning a ventilation equipment member including a coating layer containing the coating agent, and includes a step of dissolving the coating layer with water to remove the coating layer and stains adhering to the coating layer.

As a method for removing the coating layer and the stains adhering to the coating layer, for example, the stains can be easily removed by immersing the ventilation equipment member in water for about 5 minutes and rubbing it with a brush or the like if necessary. The stains can also be removed more easily by raising the temperature of the water.

Stains on the ventilation equipment member having the coating layer can be sufficiently removed only by immersing the ventilation equipment member in water or the like. As a result, the burden of cleaning work can be significantly reduced as compared with the related art.

Although descriptions were given above for the preferred embodiments of the present invention, the present invention is not limited to the aforementioned embodiments.

### EXAMPLES

### Example 1

20 g of polyoxyethylene/polyoxypropylene block polymer (hereinafter may be referred to as EO/PO block polymer) (product name: Pluronic F88, available from ADEKA Corporation) as a surfactant was dissolved in 80 mL of water to prepare a coating liquid.

### Examples 2 to 4

A coating liquid was prepared in the same manner as in Example 1 except that the surfactant in Table 1 was used as the surfactant.

### Example 5

“Neoperex G-15” (sodium laurylbenzene sulfonate aqueous solution, available from Kao Corporation), which is an aqueous solution of a surfactant, was used as a coating liquid.

### Comparative Example 1

66.7 g of betaine laurylamide propyl acetate (product name: ADEKA Anhort PB-30L, available from ADEKA Corporation,) as a surfactant was dissolved in 33.3 mL of water to prepare a coating liquid.

### Comparative Example 2

20 g of lauryl alcohol ethoxylate (product name: ADEKATOR LA-1275, available from ADEKA Corporation) as a surfactant was dissolved in 80 mL of water to prepare a coating liquid.

### Comparative Examples 3 to 5

The surfactant in Table 1 was used as a coating agent. In addition, a coating liquid obtained by melting a surfactant at a temperature equal to or higher than the melting point was used as a coating liquid.

### Comparative Example 6

10 g of sodium stearate was dissolved in 90 mL of hot water, and the solution kept in a dissolved state at a temperature of 90° C. was used as a coating liquid.

### Comparative Examples 7 and 8

80 g of the surfactant in Table 1 was dissolved as a surfactant in 20 mL of water to prepare a coating liquid.

### Comparative Example 9

The surfactant in Table 1 was used as a coating agent. Further, a coating liquid obtained by melting a surfactant at a temperature equal to or higher than the melting point was used as a coating liquid.

TABLE 1

| | | | | | | Alkyl |
|---|---|---|---|---|---|---|
| | | | | | Melting | chain |
| | | | | | point | carbon |
| | Structure | Product name | Manufacturer | Type | (° C.) | number |
| Example 1 | EO/PO block | Pluronic F88 | ADEKA | Non-ionic | 58 | 2 and 3 |
| | polymer | | Corporation | | | |
| Example 2 | EO/PO block | Pluronic | ADEKA | Non-ionic | 56 | 2 and 3 |
| | polymer | F108 | Corporation | | | |
| Example 3 | EO/PO block | Pluronic F68 | ADEKA | Non-ionic | 56-58 | 2 and 3 |
| | polymer | | Corporation | | | |
| Example 4 | Sodium lauryl | Emar 10 PT | Kao | Anionic | 204-207 | 12 |
| | sulfate | | Corporation | | | |
| Example 5 | Sodium | Neoperox | Kao | Anionic | >300 | 12 |
| | laurylbenzene | G-15 | Corporation | | | |
| | sulfonate | | | | | |
| Comparative | Lauryl amide | Adeca Unhort | ADEKA | Amphoteric | −6 | 12 |
| Example 1 | propyl betaine | PB-30L | Corporation | | | |
| | acetate | | | | | |
| Comparative | Lauryl alcohol | Adecator | ADEKA | Non-ionic | 29 | 12 |
| Example 2 | ethoxylate | LA-1275 | Corporation | | | |
| Comparative | Polyoxyethylene | Nonion | NOF | Non-ionic | 53 | 22 |
| Example 3 | behenyl ether | B-250 | Corporation | | | |
| Comparative | Polyethylene | Nonion | NOF | Non-ionic | 60 | 18 |
| Example 4 | glycol di stearate | DS-60HN | Corporation | | | |
| Comparative | Polyoxyethylene | Nonion | NOF | Non-ionic | 50 | 18 |
| Example 5 | monostearate | S-40 | Corporation | | | |
| Comparative | Sodium stearate | Sodium | FUJIFILM | Anionic | 220 | 18 |
| Example 6 | | stearate | Wako Pure | | | |
| | | | Chemical | | | |
| | | | Corporation | | | |
| Comparative | Natural alcohol | Adeca Hope | ADEKA | Anionic | 8 | 14 |
| Example 7 | ether sulfate Na | YES-25 | Corporation | | | |
| | salt | | | | | |
| Comparative | Polyoxyethylene | Kao Akipo | Kao | Anionic | 7 | 14 |
| Example 8 | lauryl ether | RLM-45NV | Corporation | | | |
| | acetate | | | | | |
| Comparative | Octadecyl amine | Nissan Cation | NOF | Cationic | 80 | 18 |
| Example 9 | acetate | SA pale | Corporation | | | |
| | | yellow | | | | |

### <Formation of Coating Layer>

The coating liquid was sprayed on a vertically standing 5 cm×10 cm galvanized steel sheet (thickness 0.8 mm) by a trigger spray (product name: Trigger Nozzle T95; spray amount per trigger is 1 mL, available from Canyon Corporation), and then it was dried at room temperature (25° C.) for 5 minutes in a vertically standing state. Thereafter, the galvanized steel sheet was turned upside down and dried at room temperature for another hour to form a coating layer. The application amount was such that the weight of the coating layer was from 0.03 to 0.06 g. In Comparative Examples 3 to 5 and 9, the surfactant was melted at a temperature equal to or higher than the melting point, applied with a brush on a galvanized steel sheet, and cooled to form a coating layer.

After forming the coating layer, the surfactant was collected from the galvanized steel sheet and the melting point was measured. The results are shown in Table 1. The melting point was measured using a differential scanning calorimeter (Discovery DSC2500, available from TA Instrument).

### <Measurement of Stain Removal Rate>

A galvanized steel sheet having a coating layer formed by the above method was placed horizontally, and a hexane solution of 25% dimer acid (product name: Tsunodim 228, available from Tsuno Co., Ltd., hereinafter referred to as oil) was sprayed thereon. The application amount of oil was such that the amount of oil on the coating layer after drying at room temperature was from 0.3 to 0.6 g. After applying the oil, the galvanized steel sheet was placed horizontally in an oven at 120° C. and heated for 2 hours to bake the oil.

After cooling the heated galvanized steel sheet to room temperature, it was immersed in warm water at 40° C. for 5 minutes, and the surface of the galvanized steel sheet was wiped for 30 seconds without applying force with a toothbrush. Then, it was dried at room temperature, and the weight of the galvanized steel sheet after washing was measured. The stain removal rate was calculated by the following formula.

Stain removal rate=(X−Y×Z)/X

X: oil application amount (solid content weight)

Y: remaining amount of stains after cleaning (weight of galvanized steel sheet after cleaning−initial weight of galvanized steel sheet)

Z: oil application amount/(oil application amount+coating layer weight)

### <Measurement of Condensation Resistance>

A galvanized steel sheet on which the coating layer was formed by the above method was prepared, and a marked line was drawn on the coating layer containing a coating agent using a refill ink available from Teranishi Chemical Industry Co., Ltd.

A galvanized steel sheet with a marked line was stood vertically, the galvanized steel sheet was separated from the spray port of the trigger spray by 30 cm, water was sprayed once with the trigger spray so that water was sprayed on the entire galvanized steel sheet, and the galvanized steel sheet was dried at room temperature in a vertically standing state. This operation was repeated three times, and the disturbance of the marked line was observed.

The one in which no disturbance of the marked line was confirmed was evaluated as “A”, the one in which the disturbance was confirmed in a part of the marked line was evaluated as “B”, and the one in which the disturbance was confirmed in the entire marked line was evaluated as “C”.

### <Measurement of Flowability at High Temperature>

A coating layer was formed in the same manner as described above except that the coating liquids of Examples 1 to 5 and Comparative Examples 2 to 6 were used, and the size of the galvanized steel sheet was set to 2 cm×5 cm. A line was marked on the coating layer containing the coating agent using a refill ink available from Teranishi Chemical Industry Co., Ltd.

The galvanized steel sheet was fixed at a position of from 10 to 20 cm in diameter of a disk having a diameter of 20 cm, allowed to stand in an environment of 40° C. for 1 hour, rotated at a speed of 1200 rpm for 3 minutes, and then the disturbance of the marked line was observed.

The one in which the disturbance of the marked line was not confirmed was evaluated as “A”, and the one in which the disturbance of the marked line was confirmed was evaluated as “B”.

Table 2 shows the results of each measurement.

TABLE 2

| | Oil stain removal | Condensation | Flowability at |
|---|---|---|---|
| | rate (%) | resistance | high temperatures |
| Example 1 | 92 | A | A |
| Example 2 | 91 | A | A |
| Example 3 | 89 | A | A |
| Example 4 | 89 | A | A |
| Example 5 | 92 | B | A |
| Comparative | 87 | C | — |
| Example 1 | | | |
| Comparative | 85 | C | B |
| Example 2 | | | |
| Comparative | 78 | B | A |
| Example 3 | | | |
| Comparative | 65 | A | A |
| Example 4 | | | |
| Comparative | 60 | B | A |
| Example 5 | | | |
| Comparative | 76 | A | A |
| Example 6 | | | |
| Comparative | 53 | C | — |
| Example 7 | | | |
| Comparative | 53 | C | — |
| Example 8 | | | |
| Comparative | 39 | A | — |
| Example 9 | | | |

1. A coating agent for kitchen ventilation equipment, comprising an anionic or nonionic surfactant having an alkyl chain, the alkyl chain having 16 or less carbon atoms, and the surfactant having a melting point of 50° C. or higher.

2. The coating agent for kitchen ventilation equipment according to claim 1, wherein the surfactant is an anionic surfactant selected from the group consisting of sulfonate-based surfactants and sulfate-based surfactants.

3. The coating agent for kitchen ventilation equipment according to claim 1, wherein the surfactant is a nonionic surfactant having a polyoxyalkylene block.

4. A coating liquid for kitchen ventilation equipment, comprising the coating agent for kitchen ventilation equipment according to claim 1 and a solvent.

5. The coating liquid for kitchen ventilation equipment according to claim 4, wherein the content of the surfactant in the coating liquid for kitchen ventilation equipment is from 3 to 50% by mass.

6. A kitchen ventilation equipment member, comprising a coating layer containing the coating agent for kitchen ventilation equipment according to claim 1.

7. A method for facilitating cleaning of a kitchen ventilation equipment member, comprising a step of forming a coating layer containing the coating agent for kitchen ventilation equipment according to claim 1 on the kitchen ventilation equipment member.

8. A method for cleaning a kitchen ventilation equipment member comprising a coating layer containing the coating agent for kitchen ventilation equipment according to claim 1, wherein the coating layer is dissolved in water to remove the coating layer and stains adhering to the coating layer.
